(19) United States
(12) Patent Application Publication
(10) Pub. No.: US 2021/0175968 A1
(43) Pub. Date: Jun. 10, 2021

(54) System, Method, and Program Product for Characterizing Multilevel PAMn Eye Diagrams in Communication Systems

(71) Applicant: Donghong Wu, Union City, CA (US)

(72) Inventor: Donghong Wu, Union City, CA (US)

(21) Appl. No.: 17/111,436

(22) Filed: Dec. 3, 2020

Related U.S. Application Data
(60) Provisional application No. 62/943,498, filed on Dec. 4, 2019.

(51) Int. Cl. H04B 10/079; H04B 10/516

(52) U.S. Cl. CPC H04B 10/0799; H04B 10/5161

(57) ABSTRACT

A system, program product, and method comprising the steps for: superimposing or plotting the signal trace data on a multilevel Pulse Amplitude Modulation (PAMn) eye diagram; identifying at least three (3) transition states of the signal trace; determining an eye height (EH) and/or eye width (EW) of an eye opening of the signal trace; finding an optimal central axis of the signal trace eye opening; plotting a diamond shaped inner mask within the signal trace eye opening; and applying a mask test on said PAMn eye diagram.

### CROSS-REFERENCE TO RELATED APPLICATIONS

The present Utility patent application claims priority benefit of the U.S. provisional application for patent serial number 62/943,498 entitled “Methods of Characterizing Pam4 Eye Diagram”, filed on Dec. 4, 2019 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to signal analysis. More particularly, certain embodiments of the invention relate to a comprehensive data analysis solution for characterizing multilevel Pulse-amplitude modulation (PAM) eye diagrams in high-speed serial communication systems.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Typical optical transceivers may play an essential role in data center and telecom network because the optical transceivers may be used to convert electrical signals to light signals and vice versa to transfer data. In fiber optic networks, data may be sent via an optical fiber in the form of pulses of light in order to keep data travel at very high speeds across long distances. Pulse-amplitude modulation (PAM), called serial communications, is a form of signal modulation where message information is typically encoded in the amplitude of a series of signal pulses. A conventional mechanism used in serial communication may be binary non-return to zero (NRZ). NRZ modulation may have two voltage levels to represent logic 0 and logic 1, commonly known as PAM2. Because a disadvantage of NRZ modulation may be higher channel-dependent loss, PAMn (wherein n>2), specifically PAM4, has become a more viable solution in high-speed communication network. In PAM4, information may be passed by modulating the pulse amplitude with no regard to phase. PAM4 uses 4-level signaling and may transmit two bits per unit interval (UI) also called a symbol, and thus uses half the bandwidth compared to traditional PAM2-NRZ coding. Although there may be an increase in usage of PAM4 standards in the high-speed interconnector industry, the measurement implementation of the PAMn products may be a substantial challenge when using traditional testing methodology for NRZ signals.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that an eye diagram (eye pattern) test may be an essential measurement for a typical optical transceiver. When a series of optical signals with a standard test pattern are sent to a transceiver, output signals of the device under test (DUT) may be received on an oscilloscope and processed to create the eye diagram. Eye diagram analysis may play a key role in characterizing both optical and electrical signals in high-speed serial communication because it allows various features of signals, including quality and statistical information, to be quickly visualized and determined. For example, without limitation, an NRZ eye diagram with only one eye may be easily and effectively characterized by utilizing the eye mask test method. However, great challenges may exist in characterizing a PAMn eye diagram when applying the eye mask test method. Unlike NRZ, a PAMn (n>2) signal may have, for example, without limitation, more eyes of varying asymmetry, smaller eye openings and complicated transition processes. All of these factors may contribute to the difficulty in defining the geometric details of the eye and characteristics of the PAMn eye diagram. In a conventional method, eye height (EH₆) and eye width (EW₆) may be the two most important parameters to be determined in the PAM4 eye diagram. However, both parameters, EH₆ and EW_{6,} may only be tested and determined by concurrently running an additional test procedure on a receiver (Rx) to produce bathtub curves at a bit error rate (BER) of 10E-6. Because EH₆ and EW₆ may not be test data of transmitter (Tx) and bit error rate testing (BERT) may be a time and equipment extensive test procedure, only limited parameters on the PAMn eye diagram may be analyzed and determined. For instance, the mask method well-used in NRZ testing may not be usable in PAMn testing even after EH₆ and EW₆ are determined.

One of the critical points in conventional methods may be the classification of signal traces on the PAMn eye diagram. Typically, one may identify the traces and lanes with only two states, Start and End. This analysis model may lead to an incomplete object and absence of useful information during the eye diagram analysis, since traces on the PAMn eye diagram typically comprise n states in two unit-intervals (UI). For example, without limitation, existing analyzing models may only be able to capture the existence of 16 distinct transition lanes in the PAM4 eye diagram, in which only a UI may be taken into account. In comparison, there may be 64 identifiable, distinct lanes based on 2 UI in the present solution. A second critical point is about the model of distribution of signal traces over the concentrated layer around an eye. Conventional models and oscilloscope software may apply a Gaussian distribution to the overall layer along either an x or y axis, no matter how many different transition lanes are in the overall layer. The model limits further data analysis in the scale of the transition lane and may fail to handle complicated transition processes on the PAMn eye diagram.

Jitter analysis may be another essential testing method in the high-speed serial communications because jitter levels and degraded waveforms may greatly affect signal quality in an optical network. In jitter analysis, total jitter (TJ) may be divided into two components, deterministic jitter (DJ) and random jitter (RJ), each of which may be further classified by additional mechanisms. For example, without limitation, a dual-Dirac jitter model may be used for noise analysis along a horizontal or time axis of the NRZ eye diagram. However, it is a difficulty to apply the analysis method on the PAMn (n>2) eye diagrams due to their complex structures on the horizontal axis. In addition, there may be no appropriate models or quantitative algorithms in jitter analysis for the PAMn eye diagram in existing solutions. Transmitter dispersion eye closure quaternary (TDECQ) was introduced to measure dispersion penalty of vertical amplitudes of the PAM4 eye diagram. Unfortunately, its parameter, TDECQ may be a measurement of the distribution only after a series of adjustment process, likely in a black box, is completed. It is typically a measurement of relative value and may not give absolute value of the original distribution of PAM4 Tx signals.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary PAMn (n=4) eye diagram and three sampling slots for identifying transition states of traces and lanes, in accordance with an embodiment of the present invention;

FIG. 2 illustrates a flow chart of an exemplary method for identifying and calibrating transition states of traces with a standard test pattern, in accordance with an embodiment of the present invention;

FIG. 3A-3B illustrate exemplary visual representations for eye openings, wherein FIG. 3A shows a histogram of two adjacent levels on a vertical axis and FIG. 3B shows a dual-lane eye opening model for determining an eye opening, in accordance with an embodiment of the present invention;

FIG. 4 illustrates a flow chart of an exemplary method for determining an eye opening at any point on either an x or y axis of a PAMn eye diagram, in accordance with an embodiment of the present invention;

FIG. 5 illustrates a flow chart of an exemplary method for making eyes wide open and characterizing dispersions and errors in the level scale with the vertical lane analysis, in accordance with an embodiment of the present invention;

FIGS. 6A-6C illustrate flow charts of exemplary methods for analyzing eye diagrams, wherein FIG. 6A shows a method for characterizing a PAMn eye diagram from import data, FIG. 6B shows a method for plotting a diamond inner mask and an inner lane group, and FIG. 6C shows a method for applying a mask test on a PAMn eye diagram, in accordance with an embodiment of the present invention;

FIG. 7 illustrates an exemplary dataset of amplitudes on a PAM4 eye diagram for data analysis, in accordance with an embodiment of the present invention;

FIG. 8 illustrates an exemplary PAM4 eye diagram with inner masks, inner lanes and testing masks, in accordance with an embodiment of the present invention;

FIG. 9A-9C illustrate exemplary plots of inner masks and associated inner lanes on a PAM4 eye diagram, wherein FIG. 9A shows an upper eye characterization, FIG. 9B shows a middle eye characterization, and FIG. 9C shows a lower eye characterization, in accordance with an embodiment of the present invention;

FIGS. 10A-10B illustrate exemplary visual representations related to traces, wherein FIG. 10A shows a plot of three masks hit by traces and FIG. 10B shows a table listing traces classified by inner hits and outer hits on a PAM4 eye diagram, in accordance with an embodiment of the present invention;

FIG. 11 illustrates an exemplary boxplot of all lanes in a concentrated level on the PAM4 eye diagram for vertical lane analysis, in accordance with an embodiment of the present invention;

FIG. 12 illustrates an exemplary histogram of several lanes in a level on a PAM4 eye diagram for vertical lane analysis, in accordance with an embodiment of the present invention;

FIG. 13 is a block diagram depicting an exemplary client/server system which may be used by an exemplary web-enabled/networked embodiment of the present invention; and

FIG. 14 illustrates a block diagram depicting a conventional client/server communication system, which may be used by an exemplary web-enabled/networked embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

The following abbreviations and/or acronyms may be used with reference to the figures and description set forth herein: Pulse Amplitude Modulation (PAM), multilevel PAM (PAMn, wherein n may be greater or equal to 2), non-return-to-zero (NRZ), bit error rate test (BERT), unit intervals (UI), device under test (DUT), standard deviation (std), transmitter (Tx), receiver (Rx), eye height (EH), eye width (EW), transmitter dispersion eye closure quaternary (TDECQ), Pseudo Random Binary Sequence (PRBS), Analysis of Variance (ANOVA), sum of squares between groups: treatment (SSB), sum of squares within groups: errors (SSW), sum of squares total (SST), deterministic jitter (DJ), random jitter (RJ), total jitter (TJ), Intersymbol interference (ISI), optical modulation amplitude (OMA), and vertical eye closure (VEC).

Furthermore, the following terms may be used with reference to the figures and description set forth herein. Signaling may be transmitter information, UI may be a unit interval on an oscilloscope, which may be converted to a millisecond (ms) or picosecond (ps) on time scales. UI may be used in data analysis to, for example, without limitation, achieve same scale eye diagrams for signals with different data rates. Trace or Signal trace may be an elementary element on scope which may comprise a series of sampling signals with time. Lane may comprise of signal traces having the same transition process from a Start state to an End state. Level may be identified on a vertical level at an eye center location, and may consist of several lanes having the same logic coding level. Mask hits may be the number of traces which hit or cross a mask on the screen of an oscilloscope.

Moreover, the pseudo random binary sequence (PRBS) pattern may be often used as a model data to test a high-speed serial interface device for emulating a mission mode. PRBS pattern is a mathematically randomized bit stream so that it may be a well neutralized and balanced data. Analysis of variance (ANOVA) is a statistical method that may separate an observed variance data into different components to use for additional tests. A one-way analysis of variance (ANOVA) may evaluate an impact of a sole factor on a sole response variable. One-way may point to a number of independent variables in the analysis of variance test. One-way ANOVA may be used to determine whether there are any statistically significant differences between the means of two or more independent groups of data. The transmitter dispersion eye closure quaternary (TDECQ) may be a measure of each optical transmitter's vertical eye closure when transmitted through a worst-case optical channel (and Signal to Noise Distortion Ratio (SNDR) for electrical).

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognized in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hollinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit —“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . .” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

While embodiments herein may be discussed in terms of a processor having a certain number of bit instructions/data, those skilled in the art will know others that may be suitable such as 16 bits, 32 bits, 64 bits, 128s or 256 bit processors or processing, which can usually alternatively be used. Where a specified logical sense is used, the opposite logical sense is also intended to be encompassed.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, (for data analyses:) Python, R, Scala, Julia, Matlab, Ruby, Perl, Javascript, (for embedded systems:) C, C++, Java, Assembly, Rust, Ada, Go, Lua, B#, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java.™., Jini.™., C, C++, Smalltalk, UNIX Shell, Visual Basic or Visual Basic Script, Virtual Reality Markup Language (VRML), ColdFusion.™. or other compilers, assemblers, interpreters or other computer languages or platforms.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, removable media, flash memory, a “memory stick”, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM.®. MQSeries.®. technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Additionally, the phrase “configured to” or “operable for” can include generic structure (e.g., generic circuitry) that is manipulated by software and/or firmware (e.g., an FPGA or a general-purpose processor executing software) to operate in a manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

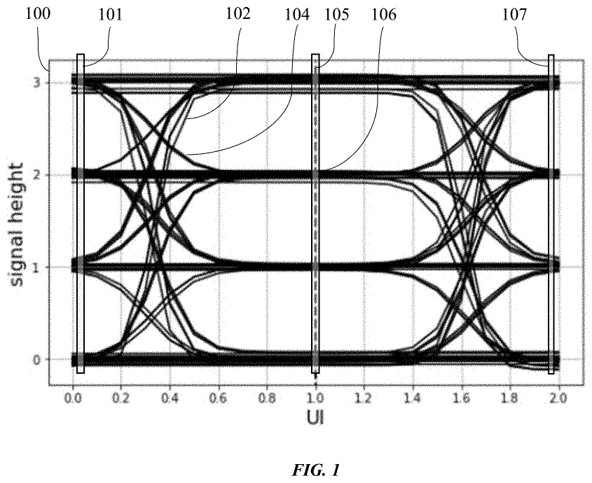

FIG. 1 illustrates an exemplary PAMn (n=4) eye diagram and three predefined sampling slots for identifying transition states of signal traces and lanes, in accordance with an embodiment of the present invention. A multilevel PAMn eye diagram for data analysis may be set as two Unit Intervals (UI) in range of the x axis and n signal levels from 0 to n-1 in the y axis. There may be three elements superimposed or plotted on the multilevel PAMn eye diagram: signal trace 102, lane 104 and level 106. A signal trace, or elementary element on scope, may comprise a series of sampling signals within a predefined period of time. A lane may comprise traces having the same transition processes from start state to end state. A level, which may be identified at a vertical level at an eye center axis, may comprise several lanes having the same logic coding level. To identify and classify traces and lanes of an eye diagram of a generic multilevel PAMn type, three transition states (Start, Level, and End) may be used to label the traces and lanes. The average amplitudes in the three predefined time slots may be evaluated to be the transition states, where slot 101 may be Start, slot 105 may be Level, and slot 107 may be End. By counting the number of permutations of n levels, the distinct lanes of a level may be n² and the total distinct lanes of a multilevel PAMn eye diagram may be n³.

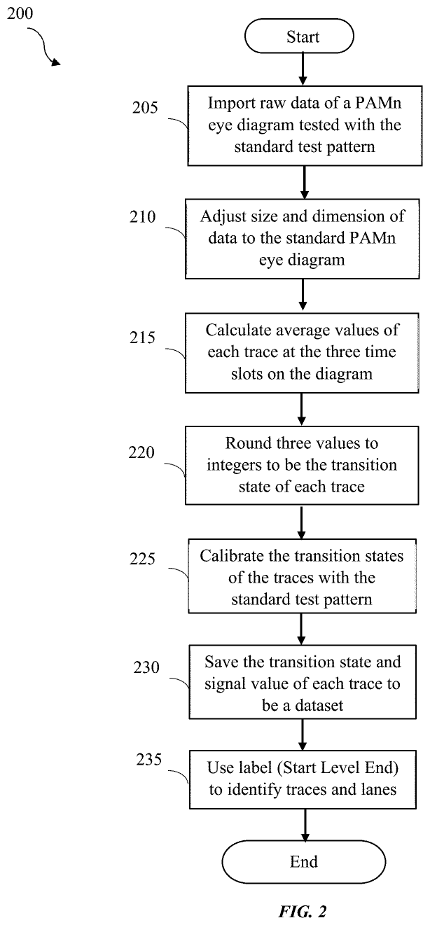

FIG. 2 illustrates a flow chart of an exemplary method for identifying and calibrating transition states of signal traces including but not limited to optical and electrical signals with a standard test pattern, in accordance with an embodiment of the present invention. If raw data of the multilevel Pulse Amplitude Modulation (PAMn) eye diagram obtained from an oscilloscope or digital devices has only amplitude values of traces, the raw data must be identified with three transition states before data analysis and characterization. To obtain the dataset with three transition states, one may use the raw data of a device under test (DUT) tested with the standard test pattern, such as Pseudo Random Binary Sequence (PRBS15). First, the raw data of a PAMn eye diagram may be imported in a step 205 of method 200. In a step 210 of method 200, a dimension and central location of the data may be adjusted to the PAMn eye diagram by aligning the eye center to the central area of screen and setting scale of the diagram to 2 UI on x-axis. In a step 215 of method 200, three average amplitude values of each signal trace within three (3) predefined sampling time slots on the diagram may be calculated by reading the interpolated amplitude within each time slot of the trace and designated as three (3) transition states. The three (3) transition states, Start, Level and End of each signal trace may then be determined with rounded integer numbers of the average values in a step 220 of method 200. The new dataset obtained above may be calibrated with a known signal coding profile of a test pattern 225. For instance, one may concatenate the three states of all traces on a PAM4 eye diagram to be a series of data string comprising from 0 to 3. Because the DUT may be tested with the PRBS15 test pattern, which may have a certain pattern length, known signal coding profile and a special integer string, such as, but not limited to, ‘111111113333333’, the signal coding profile of the PAM4 eye diagram may be aligned with the special string or other identified coding string, so that the transition states of each trace on the PAM4 eye diagram may be identified and calibrated. In a step 230 of process 200, a new dataset may be saved for data analysis 230. Thus, each trace in the dataset may be labeled with its transition states, (Start state, Level state, End state) for data analysis in a step 235. The method 200 may be implemented in a variety of different applications, such as, but not limited to, an application programming interface (API) in Oscilloscope software, firmware in digital devices, a standalone program for data analysis, etc.

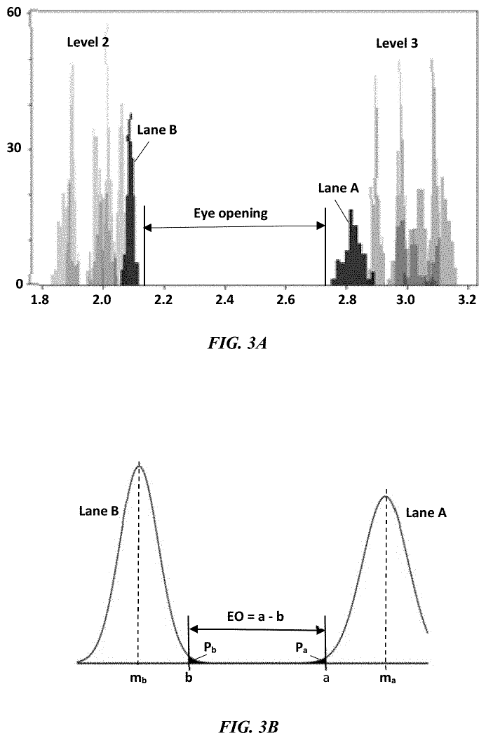

FIG. 3A-3B illustrate exemplary visual representations for eye openings of the signal trace, wherein FIG. 3A shows a histogram of two adjacent levels on a vertical axis and FIG. 3B shows a dual-lane eye opening model for determining an eye opening of the signal trace, in accordance with an embodiment of the present invention. Based on the classification of three transition states, the lanes in each histogram may be easily identified and separated. When the eye opening is related to the two inner lanes closest to the eye center, rather than all signal traces in the two adjacent layers in the existing solution, the system may be simplified as a dual-lane eye opening model, as shown in FIG. 3B. In statistics, the scale value of a signal trace may be a lane, rather than a level or a layer. By establishing the relationship between the eye opening and a probability of an event on the dual-lane model, two inner edges, a and b of two inner lanes may be calculated with signal mean and standard deviation of the inner lanes according to the following formula:

Edge (a, b)=mean±k*standard deviation

where k may be a z-score for a Gaussian distribution or larger for a non-Gaussian distribution. If the probability of the dual-lane eye opening model on PAM4 signals is 10E-6, the constant k may be 3.09 at a significance level of 0.001. Thus, the eye opening, either eye height (EH) or eye width (EW), may be determined using the distance between the two inner edges of the two inner lanes according to the following formula:

Eye opening=(mₐ−k*sₐ)−(m_{b}+k*s_{b})

Where mₐ may be the mean of lane a, sₐ may be the standard deviation of lane a, m_{b} may be the mean of lane b, and s_{b} may be the standard deviation of lane b. The formula may be used to determine an eye opening using only the sampling mean and standard deviation of two inner lanes, once the position on the x or y axis of the PAMn eye diagram is given. Unlike EH₆ and EW₆ in a conventional method, both eye height (EH) and eye width (EW) may be calculated with a dataset and software program in a relatively short time, which may greatly reduce cost in both time and equipment.

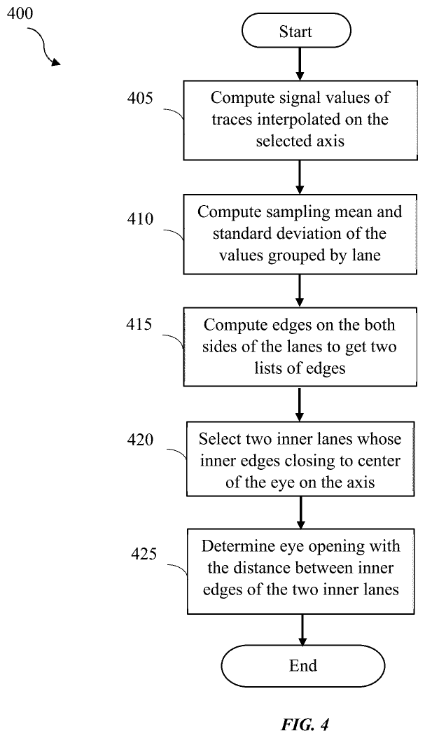

FIG. 4 illustrates a flow chart of an exemplary method for determining an eye opening of the signal trace at any point on either an x or y axis of a PAMn eye diagram, in accordance with an embodiment of the present invention. In a step 405 of method 400, new signal values of all traces interpolated at the selected axis may be computed for data analysis. A sampling mean and standard deviation of the signal trace values grouped by lane may then be computed in a step 410 of method 400. In a step 415 of method 400, two lists of lanes may be obtained by adding two edges on the lanes. Subsequently, two inner lanes, identified by their inner edges closest to the eye center, may be selected from the two lists of lanes in a step 420 of method 400. In a step 425 of method 400, the eye opening may be determined using the distance between the inner edges of the two inner lanes. Method 400 may be used to determine either EH or EW of an eye on a PAMn eye diagram.

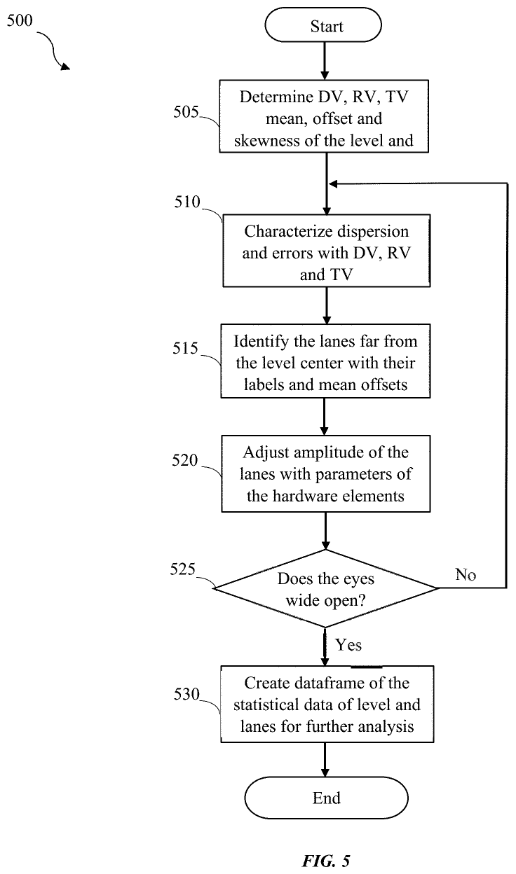

FIG. 5 illustrates a flow chart of an exemplary method for making eyes wide open and characterizing dispersions and errors in the level scale with the vertical lane analysis, in accordance with an embodiment of the present invention. Vertical lane analysis may be a signal amplitude analysis on a proximate central axis of a PAMn eye diagram. More particularly, PAMn eye diagram may comprise of, but not limited, to a PAM4 eye diagram and vertical lane analysis may comprise of, but not limited to, a one-way analysis of variance (ANOVA) in a concentrated signal trace layer. Variances (i.e. squares of the standard deviations) may be a measure of dispersion and noise, which may correspond to two components in vertical lane analysis, Deterministic Variance (DV) and Random Variance (RV). Total Variance (TV) may be the sum of DV and RV. To perform the vertical lane analysis, One-Way analysis of variance (ANOVA) may be applied. Therefore, the three components of variances in vertical lane analysis can be determined using mathematical formulas of one-way ANOVA. As such, DV may be calculated using the formula:

DV=Σⱼ₌₁^{k}nⱼ(mⱼ−m)²

where m may be the mean of the level, k may be the number of lanes, nⱼ may be the trace size and mⱼ may be the mean of lane j in the level. Similarly, RV may be calculated using the formula:

$$RV = {\sum }_{j = 1}^{k} {\sum }_{i = 1}^{n} {( {y}_{ij} - {m}_{j} )}^{2}$$

where yᵢⱼ may be the amplitude of a trace i at a lane j. Finally, DV and RV may be summed to determine TV, according to the following formula:

TV=DV+RV

In statistics, DV is a dependent variable of the system, i.e. DV values may be changeable if the design parameters of the device under test (DUT) are modified. Therefore, DV may be used to characterize dispersion or intersymbol interference (ISI) in the level scale on the PAMn eye diagram, while tuning parameters of the hardware to open the eyes. On the other hand, RV may be a fixed variable when adjusting DUT parameters, which may be the minimum TV of DUT. As all lanes in the level overlap, DV may approach zero and thus TV=RV. Unlike other eye parameters, the vertical lane analysis may be performed in the eye central area no matter the eyes are opened, small or closed. For example, when using the method to TDECQ testing, one may determine DV of each level in both initial poor eye diagram and final good eye diagram, so that the ISI of the DUT system in the TDECQ testing may be determined.

The procedure to make eyes wide open and characterize the concentrated level layers on the PAMn eye diagram with the vertical lane analysis is described in a method 500. The statistical parameters of the level, without limitation, such as DV, RV, TV, mean, offset and skewness, may be quickly calculated on the selected central axis in a step 505 of method 500. DV, RV and TV may be used for characterizing dispersion, the minimum variance and total variances of DUT's level scale in a step 510 of method 500. In addition, DV may be used to characterize divergence of the level whether the eyes are open, small or closed. RV may be used to characterize the minimum width of the level when DV approaches zero. The lanes far away from the level mean may be identified with their labels and mean offsets, and may be mapped to the associated parameters of DUT elements in a step 515 of method 500. Thus, the eye may be opened or improved by adjusting amplitudes of the lanes as changes of the related DUT parameters in a step 520 of method 500. The associated parameters of the device under test (DUT) may be adjusted to open the eye when it is small or closed eye. The tuning procedures may be repeatedly processed until a satisfied quality of eyes in a step 525 of method 500 may be obtained. Finally, a data frame of the statistical data of levels and lanes may be created for further data analysis in a step 530 of method 500. The parameters and results of the data analysis may be reported with tables and graphic charts such as, but not limited to, histogram, correlation plot and boxplots, etc.

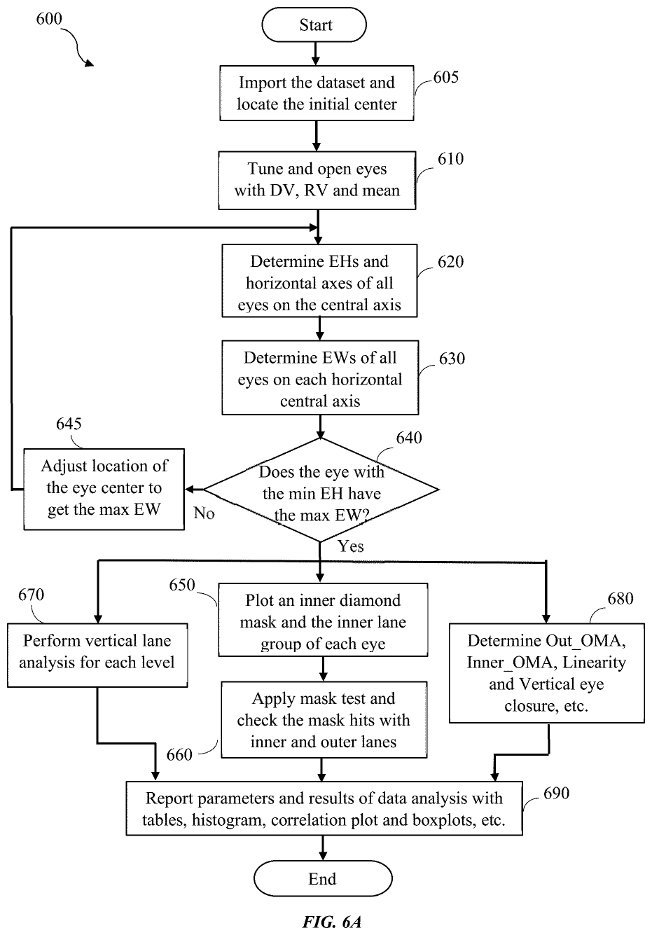

FIGS. 6A-6C illustrate flow charts of exemplary methods for analyzing PAMn eye diagrams, wherein FIG. 6A shows a method for characterizing a PAMn eye diagram from import data, FIG. 6B shows a method for plotting a diamond shaped inner mask and an inner lane group, and FIG. 6C shows a method for applying a mask test on a PAMn eye diagram, in accordance with an embodiment of the present invention. Finding an optimal central axis may be a key step in increasing analysis accuracy while characterizing a PAMn eye diagram. Since the worst case of a parameter may be the testing spec of the DUT, the condition for an optimal central axis may be where a proximate maximum eye width (EW) of an eye and a proximate minimum eye height (EH) may be found. In a step 605 of method 600, the vertical lane analysis may be applied to open the small or closed eyes. In a step 620 of method 600, EHs and horizontal axes of all eyes on a central axis may be determined. Subsequently, EWs may be determined of all eyes on each horizontal central axis. In a step 640 of method 600, it may be determined whether or not a signal trace eye opening with a minimum EH and maximum EW has been found. If not, the location of the current eye center may be adjusted to locate and achieve a maximum EW in a step 645 of method 600. Method 600 may then continue through steps 620 through 640 until an eye with a minimum EH and maximum EW has been found. Thus, the location of the new central axis may be the optimal central axis of the PAMn eye diagram. With the new vertical central axis, EHs and EWs of all eyes must be computed again. Therefore, the characteristics of the worst eye with the minimum EH may not solely become a specification of the eye diagram, but pairs of EHs and EWs with better accuracy may also be used for further data analyses. To investigate features of each signal trace eye opening on the PAMn eye diagram, a diamond shaped inner mask may be plotted by using the EH and EW, and the corresponding inner lane group may be identified with their transition states in a step 650 of method 600. Further details regarding step 650 may be described below with reference to FIG. 6B. With the locations of optimal signal trace eye centers, the predefined mask may be imported into the PAMn eye diagram to run the mask testing in a step 660 of method 600. Further details regarding step 660 may be described below with reference to FIG. 6C. Additionally, the vertical lane analysis may be performed again in a step 670 of method 600. In a step 680 of method 600, with the obtained geometrical details from analyses above, other characteristics of the PAMn eye diagram, such as, without limitation, Outer OMA, Inter OMA, Linearity, Transmitter Linearity, and Vertical Eye Closure, etc. may be determined with higher accuracy in a step 680 of method 600. Finally, the characteristics of the PAMn eye diagram determined in steps 610-680 may be summarized and reported with, for example, without limitation, tables, histograms, fitting curves, boxplots, etc. in a step 690 of method 600.

With reference to FIG. 6B, with the known values of eye height (EH) and eye width (EW) of an open eye, coordinates of four (4) symmetrical points around each eye center may be calculated in a step 652 of method 650. For instance, if center location of the low eye is [x₀, y₀], and its EH₀ and EW₀ are known, coordinates of the top and the low vertexes may be [x₀, y₀+EH/2] and [x₀, y₀−EH/2], and coordinates of the left and the right vertexes may be [x₀−EW/2, y₀] and [x₀+EW/2, y₀]. Thus, a diamond shaped inner mask of the eye may be plotted by connecting the four (4) symmetrical points or vertexes inside of the eye in a step 654 of method 650. All inner lanes around center of the eye may be identified with their transition states in a step 656 of method 650. The top inner lane and bottom inner lane may be easily identified as their inner edges are close to the eye center when one determines eye height on the vertical axis. To identify the 4 inner lanes close to 4 sides of the diamond inner mask, one may divide all lanes on the horizontal central axis of the eye to be 4 groups, the left rise group, right fall group, left fall group and right rise group. The first two lane groups may be above the horizontal central axis, and other two groups may be below the axis. Furthermore, the four lane groups may be divided by the vertical central axis. The two lane groups on the left sides of the vertical axis, left rise group and left fall group, may be identified with Start state and Level state of all lanes, and the two lane groups on the right sides of the vertical axis, right fall group and right rise group, may be identified with Level state and End state of all lanes. By using the features above, the four lane groups may be identified and sorted. Therefore, the four inner lanes which close to the diamond inner mask may be determined. The number of the inner lanes of an eye may be determined to be 6 or less, as some inner lanes may be duplicated when determining EH and EW separately. More geometrical parameters of the inner lanes, such as, without limitation, slopes and coordinates of vertexes of the diamond inner mask, may be added into the plots with the linked tables for data analysis in a step 658 of method 650.

With reference to FIG. 6C, similar to an NRZ eye diagram, mask testing may be applied on the PAMn eye diagram only when the center positions of the signal trace eye openings are located. A polygon testing mask may be imported into the memory of a digital device with a 2-D data array in a step 661 of method 660. When using the diamond testing mask, for example, the 2-D data array may be a group of points, whose coordinates are based on width (W) and height (H) of the diamond mask. With the known coordinates of eye centers, vertexes of the masks against the eye centers may be accurately calculated in a step 662 of method 660. For instance, if center location of the low eye is [x₀, y₀], coordinates of the top and the low vertexes may be [x₀, y₀+H/2] and [x₀, y₀−H/2], and coordinates of the left and the right vertexes may be [x₀−W/2, y₀] and [x₀+W/2, y₀]. In a step 663 of method 660, the masks may be inserted into the PAMn eye diagram by connecting the vertexes of the masks. Subsequently, mask hits may be counted by checking the traces which hit or penetrate the masks on the eye diagram in a step 664 of method 660. In a step 665 of method 660, the mask hits of the traces may be further classified by checking whether the traces belong to the inner lane group of the eye or not. If, so, method 660 may continue with a step 666 wherein the traces may be categorized as inner lane hits. If not, in a step 667, the traces may be categorized as an outer lane hit. By plotting the polygon testing masks and the mask hits may help a user rapidly find where the masks are hit and which inner lanes the hitting traces belong to.

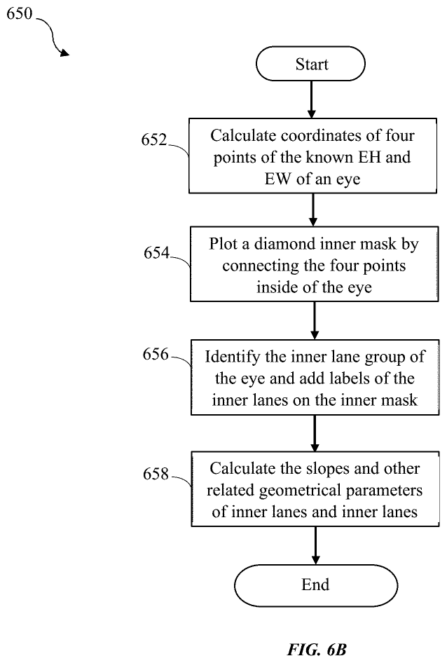

FIG. 7 illustrates an exemplary dataset of amplitudes on a PAM4 eye diagram for data analysis, in accordance with an embodiment of the present invention. Each row in the dataset may be a record of a signal trace, which may include a series of signal values at the sampling points and three properties of the traces, Start, Level and End. Only the dataset of the PAMn eye diagram with the properties, Start, Level and End may be characterized with the data analysis methods in the present disclosure.

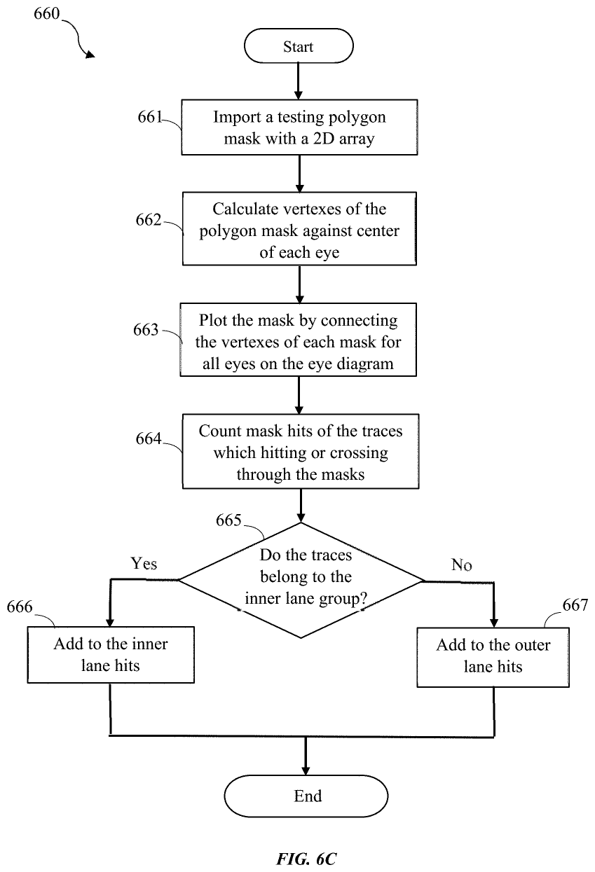

FIG. 8 illustrates an exemplary PAM4 eye diagram with inner masks, inner lanes and testing masks, in accordance with an embodiment of the present invention. FIG. 8 illustrates an example of a PAM4 eye diagram 800 comprising inner masks 804, testing masks 806, and inner lanes 802. The eye diagram may display relative positions of inner masks 804 based on the pairs of eye height (EH) and eye width (EW) of the eyes, as well as geometric relationships of the inner masks and the testing masks. Eye diagram 800 may be used to show the relative relationships of the geometrical parameters on eye diagram 800 and virtually deal with their parameters.

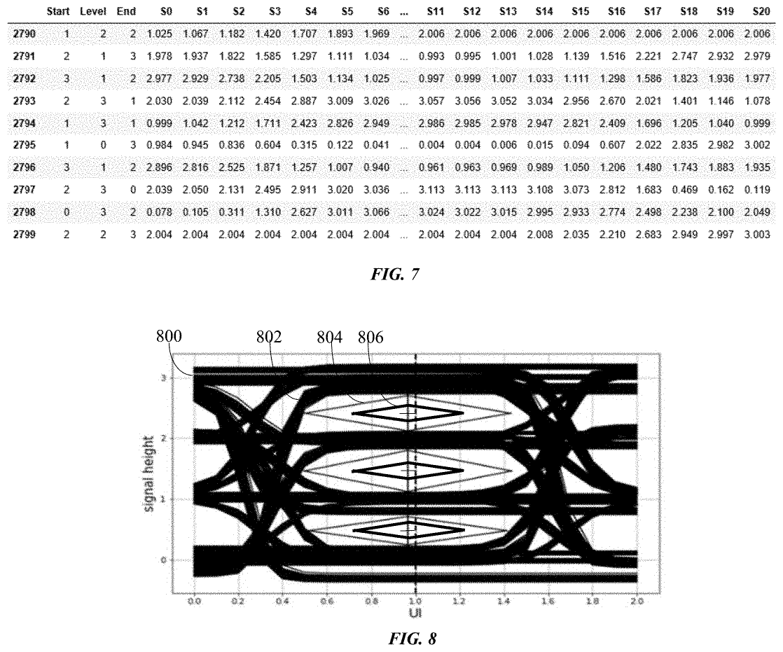

FIG. 9A-9C illustrate exemplary plots of diamond shaped inner masks and associated inner lanes on a PAM4 eye diagram, wherein FIG. 9A shows an upper eye characterization, FIG. 9B shows a middle eye characterization, and FIG. 9C shows a lower eye characterization, in accordance with an embodiment of the present invention. Introduction of the inner lanes may be significant, which may display direct relationships between an inner lane and design parameters of hardware components. By observing the geometrical parameters of the inner lanes under different testing conditions and design elements, correlations may be found between the inner lanes and design elements. Therefore, geometrical details may be quantitatively measured and analyzed by adjusting the parameters of design elements, so as to diagnose the root source of signal changes of high-speed data link during R&D, manufacture and real-time network service.

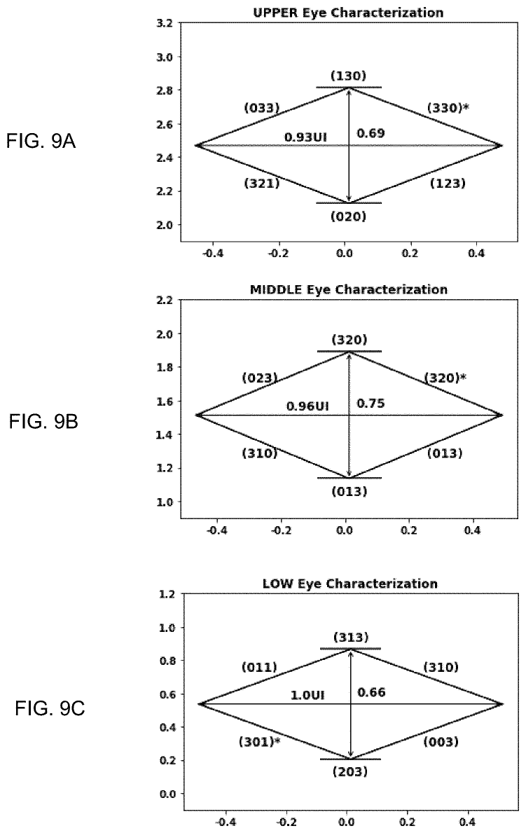

FIGS. 10A-10B illustrate exemplary visual representations related to traces, wherein FIG. 10A shows a plot of three masks hit by traces and FIG. 10B shows a table listing traces classified by inner hits and outer hits on a PAM4 eye diagram, in accordance with an embodiment of the present invention. With reference to FIG. 10A, a plot of diamond shaped testing masks hit by three traces on the PAM4 eye diagram is shown. The plot displays where and which testing masks are hit and by which traces. Therefore, the plot may be used to quickly locate the lanes of hit errors and associated hardware elements.

With reference to FIG. 10B a table listing the traces classified by inner hits and outer hits on the PAM4 eye diagram is shown. The inner hit and outer hit are identified by checking whether or not a hitting trace belongs to an inner lane group of the eye.

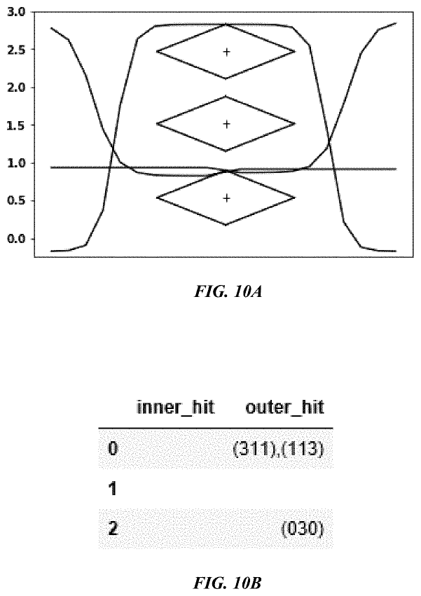

FIG. 11 illustrates an exemplary boxplot of all lanes in a concentrated level on the PAM4 eye diagram for vertical lane analysis, in accordance with an embodiment of the present invention. The plot displays the details of a signal density distribution of the lanes, such as, without limitation, the position of mean, median, skewness and shape of a lane. The plot may be a useful tool in studying the inside of a level.

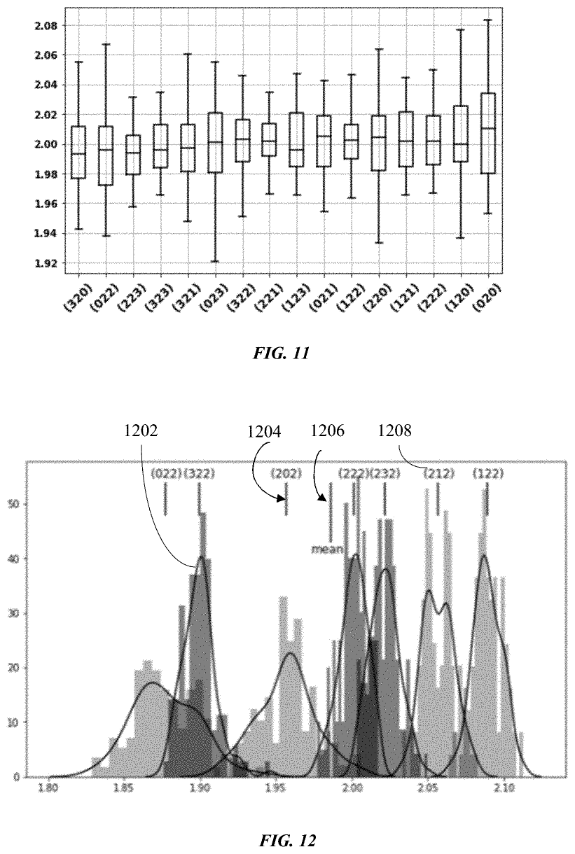

FIG. 12 illustrates an exemplary histogram of several lanes in a level on a PAM4 eye diagram for vertical lane analysis, in accordance with an embodiment of the present invention. The histogram displays a density distribution of the amplitude of seven lanes in level 2. By adding fitting curves 1202, mean of lane 1204, mean of level 1206, as well as lane labels 1208 in the vertical lane analysis, the plot may be used to display the related positions and shapes of those lanes, which may be used to study mean and profile changes of the lanes under different test conditions.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied. Such computers referenced and/or described in this disclosure may be any kind of computer, either general purpose, or some specific purpose computer such as, but not limited to, a workstation, a mainframe, GPU, ASIC, etc. The programs may be written in C, or Java, Brew or any other suitable programming language. The programs may be resident on a storage medium, e.g., magnetic or optical, e.g., without limitation, the computer hard drive, a removable disk or media such as, without limitation, a memory stick or SD media, or other removable medium. The programs may also be run over a network, for example, with a server or other machine sending signals to the local machine, which allows the local machine to carry out the operations described herein.

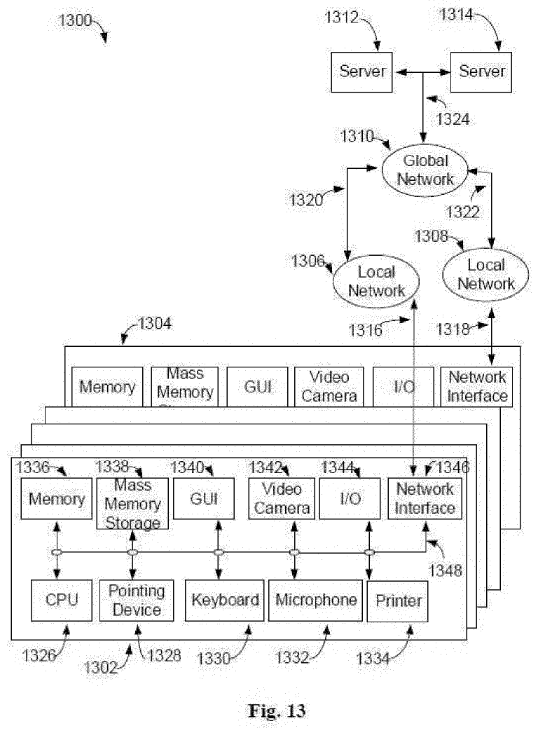

FIG. 13 is a block diagram depicting an exemplary client/server system which may be used by an exemplary web-enabled/networked embodiment of the present invention.

A communication system 1300 includes a multiplicity of clients with a sampling of clients denoted as a client 1302 and a client 1304, a multiplicity of local networks with a sampling of networks denoted as a local network 1306 and a local network 1308, a global network 1311 and a multiplicity of servers with a sampling of servers denoted as a server 1312 and a server 1314.

Client 1302 may communicate bi-directionally with local network 1306 via a communication channel 1316. Client 1304 may communicate bi-directionally with local network 1308 via a communication channel 1318. Local network 1306 may communicate bi-directionally with global network 1310 via a communication channel 1320. Local network 1308 may communicate bi-directionally with global network 1310 via a communication channel 1322. Global network 1310 may communicate bi-directionally with server 1312 and server 1314 via a communication channel 1324. Server 1312 and server 1314 may communicate bi-directionally with each other via communication channel 1324. Furthermore, clients 1302, 1304, local networks 1306, 1308, global network 1310 and servers 1312, 1314 may each communicate bi-directionally with each other.

In one embodiment, global network 1310 may operate as the Internet. It will be understood by those skilled in the art that communication system 1300 may take many different forms. Non-limiting examples of forms for communication system 1300 include local area networks (LANs), wide area networks (WANs), wired telephone networks, wireless networks, or any other network supporting data communication between respective entities.

Clients 1302 and 1304 may take many different forms. Non-limiting examples of clients 1302 and 1304 include personal computers, personal digital assistants (PDAs), cellular phones and smartphones.

Client 1302 includes a CPU 1326, a pointing device 1328, a keyboard 1330, a microphone 1332, a printer 1334, a memory 1336, a mass memory storage 1338, a GUI 1340, a video camera 1342, an input/output interface 1344 and a network interface 1346.

CPU 1326, pointing device 1328, keyboard 1330, microphone 1332, printer 1334, memory 1336, mass memory storage 1338, GUI 1340, video camera 1342, input/output interface 1344 and network interface 1346 may communicate in a unidirectional manner or a bi-directional manner with each other via a communication channel 1348. Communication channel 1348 may be configured as a single communication channel or a multiplicity of communication channels.

CPU 1326 may be comprised of a single processor or multiple processors. CPU 1326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general-purpose microprocessors.

As is well known in the art, memory 1336 is used typically to transfer data and instructions to CPU 1326 in a bi-directional manner. Memory 1336, as discussed previously, may include any suitable computer-readable media, intended for data storage, such as those described above excluding any wired or wireless transmissions unless specifically noted. Mass memory storage 1338 may also be coupled bi-directionally to CPU 1326 and provides additional data storage capacity and may include any of the computer-readable media described above. Mass memory storage 1338 may be used to store programs, data and the like and is typically a secondary storage medium such as a hard disk. It will be appreciated that the information retained within mass memory storage 1338, may, in appropriate cases, be incorporated in standard fashion as part of memory 1336 as virtual memory.

CPU 1326 may be coupled to GUI 1340. GUI 1340 enables a user to view the operation of computer operating system and software. CPU 1326 may be coupled to pointing device 1328. Non-limiting examples of pointing device 1328 include computer mouse, trackball and touchpad. Pointing device 1328 enables a user with the capability to maneuver a computer cursor about the viewing area of GUI 1340 and select areas or features in the viewing area of GUI 1340. CPU 1326 may be coupled to keyboard 1330. Keyboard 1330 enables a user with the capability to input alphanumeric textual information to CPU 1326. CPU 1326 may be coupled to microphone 1332. Microphone 1332 enables audio produced by a user to be recorded, processed and communicated by CPU 1326. CPU 1326 may be connected to printer 1334. Printer 1334 enables a user with the capability to print information to a sheet of paper. CPU 1326 may be connected to video camera 1342. Video camera 1342 enables video produced or captured by user to be recorded, processed and communicated by CPU 1326.

CPU 1326 may also be coupled to input/output interface 1344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1326 optionally may be coupled to network interface 1346 which enables communication with an external device such as a database or a computer or telecommunications or internet network using an external connection shown generally as communication channel 1316, which may be implemented as a hardwired or wireless communications link using suitable conventional technologies. With such a connection, CPU 1326 might receive information from the network, or might output information to a network in the course of performing the method steps described in the teachings of the present invention.

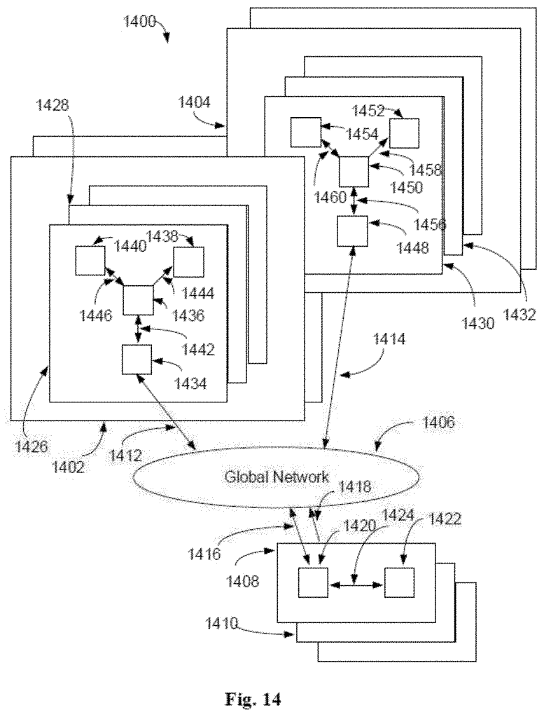

FIG. 14 illustrates a block diagram depicting a conventional client/server communication system, which may be used by an exemplary web-enabled/networked embodiment of the present invention.

A communication system 1400 includes a multiplicity of networked regions with a sampling of regions denoted as a network region 1402 and a network region 1404, a global network 1406 and a multiplicity of servers with a sampling of servers denoted as a server device 1408 and a server device 1410.

Network region 1402 and network region 1404 may operate to represent a network contained within a geographical area or region. Non-limiting examples of representations for the geographical areas for the networked regions may include postal zip codes, telephone area codes, states, counties, cities and countries. Elements within network region 1402 and 1404 may operate to communicate with external elements within other networked regions or within elements contained within the same network region.

In some implementations, global network 1406 may operate as the Internet. It will be understood by those skilled in the art that communication system 1400 may take many different forms. Non-limiting examples of forms for communication system 1400 include local area networks (LANs), wide area networks (WANs), wired telephone networks, cellular telephone networks or any other network supporting data communication between respective entities via hardwired or wireless communication networks. Global network 1406 may operate to transfer information between the various networked elements.

Server device 1408 and server device 1410 may operate to execute software instructions, store information, support database operations and communicate with other networked elements. Non-limiting examples of software and scripting languages which may be executed on server device 1408 and server device 1410 include C, C++, C# and Java.

Network region 1402 may operate to communicate bi-directionally with global network 1406 via a communication channel 1412. Network region 1404 may operate to communicate bi-directionally with global network 1406 via a communication channel 1414. Server device 1408 may operate to communicate bi-directionally with global network 1406 via a communication channel 1416. Server device 1410 may operate to communicate bi-directionally with global network 1406 via a communication channel 1418. Network region 1402 and 1404, global network 1406 and server devices 1408 and 1410 may operate to communicate with each other and with every other networked device located within communication system 1400.

Server device 1408 includes a networking device 1420 and a server 1422. Networking device 1420 may operate to communicate bi-directionally with global network 1406 via communication channel 1416 and with server 1422 via a communication channel 1424. Server 1422 may operate to execute software instructions and store information.

Network region 1402 includes a multiplicity of clients with a sampling denoted as a client 1426 and a client 1428. Client 1426 includes a networking device 1434, a processor 1436, a GUI 1438 and an interface device 1440. Non-limiting examples of devices for GUI 1438 include monitors, televisions, cellular telephones, smartphones and PDAs (Personal Digital Assistants). Non-limiting examples of interface device 1440 include pointing device, mouse, trackball, scanner and printer. Networking device 1434 may communicate bi-directionally with global network 1406 via communication channel 1412 and with processor 1436 via a communication channel 1442. GUI 1438 may receive information from processor 1436 via a communication channel 1444 for presentation to a user for viewing. Interface device 1440 may operate to send control information to processor 1436 and to receive information from processor 1436 via a communication channel 1446. Network region 1404 includes a multiplicity of clients with a sampling denoted as a client 1430 and a client 1432. Client 1430 includes a networking device 1448, a processor 1450, a GUI 1452 and an interface device 1454. Non-limiting examples of devices for GUI 1438 include monitors, televisions, cellular telephones, smartphones and PDAs (Personal Digital Assistants). Non-limiting examples of interface device 1440 include pointing devices, mousse, trackballs, scanners and printers. Networking device 1448 may communicate bi-directionally with global network 1406 via communication channel 1414 and with processor 1450 via a communication channel 1456. GUI 1452 may receive information from processor 1450 via a communication channel 1458 for presentation to a user for viewing. Interface device 1454 may operate to send control information to processor 1450 and to receive information from processor 1450 via a communication channel 1460.

For example, consider the case where a user interfacing with client 1426 may want to execute a networked application. A user may enter the IP (Internet Protocol) address for the networked application using interface device 1440. The IP address information may be communicated to processor 1436 via communication channel 1446. Processor 1436 may then communicate the IP address information to networking device 1434 via communication channel 1442. Networking device 1434 may then communicate the IP address information to global network 1406 via communication channel 1412. Global network 1406 may then communicate the IP address information to networking device 1420 of server device 1408 via communication channel 1416. Networking device 1420 may then communicate the IP address information to server 1422 via communication channel 1424. Server 1422 may receive the IP address information and after processing the IP address information may communicate return information to networking device 1420 via communication channel 1424. Networking device 1420 may communicate the return information to global network 1406 via communication channel 1416. Global network 1406 may communicate the return information to networking device 1434 via communication channel 1412. Networking device 1434 may communicate the return information to processor 1436 via communication channel 1442. Processor 14146 may communicate the return information to GUI 1438 via communication channel 1444. User may then view the return information on GUI 1438.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing systems and methods for characterizing multilevel PAM eye diagrams according to the present invention will be apparent to those skilled in the art. Various aspects of the invention have been described above by way of illustration, and the specific embodiments disclosed are not intended to limit the invention to the particular forms disclosed. The particular implementation of the systems and methods for characterizing multilevel PAM eye diagrams may vary depending upon the particular context or application. By way of example, and not limitation, the systems and methods for characterizing multilevel PAM eye diagrams described in the foregoing were principally directed to serial communication implementations; however, similar techniques may instead be applied to higher level PAMn analyses, the edge evaluation, mask test and variance analysis may be applied to test and analyze analogue signaling repeatedly measured in a fixed period, or applied to amplitude modulated signaling of electromagnetic waves in different frequency and different baud rate, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

What is claimed is:

1. A method comprising the steps for:
importing data of a signal trace;
superimposing or plotting the signal trace data on a multilevel Pulse Amplitude Modulation (PAMn) eye diagram;
identifying at least three (3) transition states of the signal trace;
determining an eye height (EH) and/or eye width (EW) of an eye opening of the signal trace;
performing a vertical lane analysis with a one-way analysis of variance (ANOVA) of the signal trace on a generally central axis of the signal trace;
finding an optimal central axis of the signal trace eye opening;
plotting a diamond shaped inner mask within the signal trace eye opening; and
applying a mask test on said PAMn eye diagram.

2. The method of claim 1, in which said step of identifying at least three (3) transition states of a signal trace comprises the steps for:
testing the device under test (DUT) data with a standard test pattern; and
designating a time slot for each of the at least three (3) transition states.

3. The method of claim 2, in which said at least three transition states comprises at least a Start state, a Level state, and an End state, wherein each of said at least three transition having a designated time slot.

4. The method of claim 1, in which said step of determining an eye height (EH) and/or eye width (EW) of the signal trace comprises the step for computing a sampling mean and standard deviation of the signal trace grouped by at least two lanes on both sides of an eye opening of a dual-lane eye opening model.

5. The method of claim 4, in which said step of determining an eye height (EH) and/or eye width (EW) of the signal trace further comprises the step for computing an edge of each of said at least two lanes to get a list of about two inner edges, wherein the list of the two inner edges are closest to an approximate center of the eye opening.

6. The method of claim 5, wherein the eye width (EW) comprises a distance between the two inner edges.

7. The method of claim 1, in which said step of performing a vertical lane analysis with a one-way analysis of variance (ANOVA) further comprises the step for determining a Deterministic Variance (DV), a Random Variance (RV), and a Total Variance (TV), wherein the Deterministic Variance (DV) is a divergence of a level whether the eye are open, small or closed.

8. The method of claim 7, in which the Total Variance (TV) is a sum of the Deterministic Variance (DV) and Random Variance (RV), wherein the Random Variance (RV) is a characterization of the minimum width of the level when the Deterministic Variance (DV) approaches zero.

9. The method of claim 8, in which said said step of performing a vertical lane analysis with a one-way analysis of variance (ANOVA) further comprises the steps for:
identifying lanes with labels which are far from a level mean; and
adjusting a parameter of a device under test (DUT) to open the eye when it is small or closed.

10. The method of claim 6, in which said step of finding an optimal central axis of the signal trace eye opening comprises the step for:
determining if the eye width (EW) is a maximum eye width (EW) and the eye height (EH) is a minimum eye height (EH) of the signal trace eye opening; and
adjusting a location of the approximate center of the signal trace eye opening if the eye width (EW) is not the maximum eye width (EW) and the eye height (EH) is not the minimum eye height (EH) among the eyes to find an approximate optimal central axis of the signal trace eye opening being operable for increasing analysis accuracy of said PAMn eye diagram.

11. The method of claim 10, in which said step of plotting a diamond shaped inner mask comprises the steps for:
calculating coordinates of four (4) symmetrical points around the proximate optimal central axis of the signal trace eye opening; and
connecting the four (4) symmetrical points to form the diamond shaped inner mask.

12. The method of claim 11, in which said step of applying a mask test on said PAMn eye diagram comprise the steps of:
importing a polygon testing mask; and
determining mask hits of the signal trace.

13. The method of claim 12, in which said step of applying a mask test on said PAMn eye diagram further comprise the steps of:
plotting the polygon testing mask on the PAMn eye diagram;
classifying the mask hits into an inner lane hit or an outer lane hit; and
plotting the mask hits on the PAMn eye diagram.

14. A program product comprising:
means for importing data of a signal trace;
means for superimposing or plotting the signal trace data on a multilevel Pulse Amplitude Modulation (PAMn) eye diagram;
means for identifying at least three (3) transition states of the signal trace;
means for determining an eye height (EH) and/or eye width (EW) of an eye opening of the signal trace;
means for performing a vertical lane analysis with a one-way analysis of variance (ANOVA) of the signal trace on a generally central axis of the signal trace;
means for finding an optimal central axis of the signal trace eye opening;
means for plotting a diamond shaped inner mask within the signal trace eye opening; and
means for applying a mask test on said PAMn eye diagram.

15. A method comprising the steps for:
superimposing or plotting the signal trace data on a multilevel Pulse Amplitude Modulation (PAMn) eye diagram;
identifying at least three (3) transition states of the signal trace;
determining an eye height (EH) and/or eye width (EW) of an eye opening of the signal trace;
performing a vertical lane analysis with a one-way analysis of variance (ANOVA);
finding an optimal central axis of the signal trace eye opening;
plotting a diamond shaped inner mask within the signal trace eye opening; and
applying a mask test on said PAMn eye diagram.

16. The method of claim 15, in which said step of identifying at least three (3) transition states of a signal trace comprises the steps for:
importing a device under test (DUT) data, wherein said data being tested with a standard test pattern;
designating a time slot for each of the at least three (3) transition state; and
in which said at least three transition states comprises a Start state, a Level state, and an End state.

17. The method of claim 15, in which said step of determining an eye height (EH) and/or eye width (EW) of the signal trace comprises the step for:
computing a sampling mean and standard deviation of the signal trace grouped by at least two lanes;
computing an edge of each of said at least two lanes to get a list of about two lane edges, wherein the two inner edges are closest to an approximate center of the eye opening; and
wherein the eye width (EW) comprises a distance between the two inner edges.

18. The method of claim 15, in which said step of performing a vertical lane analysis with a one-way analysis of variance (ANOVA) comprises the step for:
determining a Deterministic Variance (DV), a Random Variance (RV), and a Total Variance (TV);
wherein the Deterministic Variance (DV) is a divergence of a level whether the eye are open, small or closed;
in which the Total Variance (TV) is a sum of the Deterministic Variance (DV) and Random Variance (RV); and
wherein the Random Variance (RV) is a characterization of the minimum width of the level when the Deterministic Variance (DV) approaches zero.

19. The method of claim 15, in which said step of finding an optimal central axis of the signal trace eye opening comprises the step for:
determining if the eye width (EW) is a maximum eye width (EW) and the eye height (EH) is a minimum eye height (EH) of the signal trace eye opening; and
adjusting a location of the approximate center of the signal trace eye opening if the eye width (EW) is not the maximum eye width (EW) and the eye height (EH) is not the minimum eye height (EH) among the eyes to find an approximate optimal central axis of the signal trace eye opening being operable for increasing analysis accuracy of said PAMn eye diagram.

20. The method of claim 11, in which said step of applying a mask test on said PAMn eye diagram comprise the steps of:
importing a polygon testing mask;
determining mask hits of the signal trace;
plotting the polygon testing mask in the diamond shaped inner mask;
classifying the mask hits into an inner lane hit or an outer lane hit; and
plotting the mask hits on the PAMn eye diagram.
